(19) United States
(12) Patent Application Publication
(10) Pub. No.: US 2021/0331010 A1
(43) Pub. Date: Oct. 28, 2021

(54) PIPE-TYPE FIRE EXTINGUISHING EQUIPMENT FOR EXTINGUISHING FIRE INSIDE SHIP TRANSPORT CONTAINER

(71) Applicants: Jun-Ho HWANG, Busan (KR); Sang-Dong KIM, Busan (KR); Jeomkee PAIK, Busan (KR); Yong Hwan DO, Busan (KR)

(72) Inventors: Jun-Ho HWANG, Busan (KR); Jeomkee PAIK, Busan (KR); Seok-Hyun HWANG, Busan (KR)

(73) Assignees: Jun-Ho HWANG, Busan (KR); Sang-Dong KIM, Busan (KR); Jeomkee PAIK, Busan (KR); Yong Hwan DO, Busan (KR)

(21) Appl. No.: 17/271,484

(22) PCT Filed: Oct. 4, 2019
(86) PCT No.: PCT/KR2019/012987

§ 371 Date: Feb. 25, 2021

(30) Foreign Application Priority Data
Oct. 5, 2018 (KR) 10-2018-0119332

(51) Int. Cl. A62C 3/00; A62C 37/50; A62C 37/12

(52) U.S. Cl. CPC A62C 3/002; A62C 37/12; A62C 37/50

(57) ABSTRACT

Disclosed is a pipe-type fire extinguishing equipment for extinguishing a fire inside a ship transport container, including: an agent storage part installed inside the container and storing a fire extinguishing agent for extinguishing a fire; a supply pipe installed on an upper portion inside the container and connected to the agent storage part to receive and guide the fire extinguishing agent;

spray holes communicating with the supply pipe and spraying the fire extinguishing agent, which flows through the supply pipe, to the inside of the container; opening/closing members which keep the spray holes closed and open the spray holes upon being melted by heat when a fire occurs; and an alarm sound generation unit connected to the supply pipe and generating an alarm sound by means of the fire extinguishing agent which is supplied to the supply pipe when the fire extinguishing agent is sprayed through the spray holes.

### CROSS-REFERENCE TO PRIOR APPLICATIONS

This application is a National Stage Patent Application of PCT International Patent Application No. PCT/KR2019/012987 (filed on Oct. 4, 2019) under 35 U.S.C. § 371, which claims priority to Korean Patent Application No. 10-2018-0119332 (filed on Oct. 5, 2018), which are all hereby incorporated by reference in their entirety.

### BACKGROUND

The present disclosure relates to a fire extinguishing device that early detects and automatically extinguishes a fire occurring inside a container, and more particularly, a pipe-type fire extinguishing equipment for extinguishing fir inside ship transport container capable of automatically spraying a fire extinguishing agent to an inside of the closed container in a powerless method when a fire occurs to extinguish the fire and at the same time, operating a mechanical fire alarm to transmit a fire occurrence signal to the outside.

In recent years, container carriers have become supersized for large-scale maritime logistics, and cargo carried on container ships enters the container and is sealed and closed. Accordingly, a fire may occur in the container itself during maritime transportation regardless of a hull part due to the exothermic reaction of an impact, friction, static electricity, spontaneous ignition, and mixed ignition of an internal material, and an exothermic reaction between water-inhibited substances and rainwater, moisture, and other moisture.

In relation to this, the fire safety standards for ships and containers according to the international maritime transport insurance standards were established in the old age when sea cargo was open, and International Union of Marine Insurance (IUMI) points out problem of fire inside containers.

In 2018, a fire occurred in a container of a super-large container carrier called “Maersk Honam”, and the fire continued for 40 days, causing direct and indirect astronomical losses to shipping companies, ships, shippers and maritime carriers.

The fire mentioned above is a typical maritime ship fire reported in the media in 2018, but according to the Heinrich Safety Law, it is estimated that one representative fire occurred in the world, although 15 serious accidents were not reported to the media on container carriers being transported around the world.

In addition, according to Allianz Global Corporate & Specialty (AGCS) Safety and

Shipping Review, 2017, a rate of loss due to fire out of the total accident rate of container ships that occurred between 2007 and 2016 accounts for 10 to 20% of the total loss rate each year.

The fire inside the container differs in heat and smoke emitted in the event of a fire according to a Heat Release Rate (HRR) according to the material characteristics, and due to the structural characteristics of the inside of the container, it is difficult to detect the fire, and crews, fire boats, and firefighting aircrafts cannot put foam, seawater, and powdered chemicals for fire suppression to the inside of the container. Therefore, the fire is prolonged, and in a case of a fire of chemical substances and industrial products with high calorific value, heat emitted during the fire is transferred to adjacent containers through conduction, convection, and radiation, which cause a major cause of damage.

In addition, if a material that causes a fire is a material that generates an exothermic reaction when the material comes into contact with moisture, the use of foam or seawater used as the fire extinguishing agent acts as a factor that expands the fire. Accordingly, fire extinguishing tactics are limited, a powder fire extinguishing agent should also directly contact the flame to generate the extinguishing effect, and thus, spraying the outside of the container cannot exhibit the extinguishing effect.

As a related secondary side effect, in the case of container fire, crews and firefighters in fire boats do not know a type of cargo inside the container fire. Therefore, when the fire suppression is performed using foam and sea water indiscriminately, in a case where the substances inside the container are the water-inhibited substances, the moisture enters from the outside of the container to the inside thereof, and thus the exothermic reaction is generated, which acts as a factor that further induces the fire.

Even when seawater is used to extinguish a fire in a container filled with non-water inhibited substances, in a case where a total amount of heat generated in the fire is large, the seawater evaporates immediately from the outside of the container and acts as a cause of ineffective fire suppression. Moreover, due to a container loading structure in a ship, when a fire occurs in the top container, a container contact surface of seawater is large, and thus it is possible to expect a cooling effect to some extent. However, when a fire occurs in a middle loading section or a lowermost container, the seawater comes into contact with only one surface of the container, and thus, in the case of a fire in a densely loaded ship transport container, there is a great difficulty in extinguishing the fire.

In the case of a container fire that occurs on land, firefighters first destroy and cut the container and try to directly extinguish the fire of items inside, because they are well aware of this problem.

In terms of economy, a maritime transportation insurance premium per ISO-recognized standard container for maritime transportation is 30 million KRW for normal cargo and 300 million KRW for high-priced cargo such as electronic products, and carrier charges a freighter by adding these premiums to a freight charge.

However, even when the container fire causes damage to the hull structure, if a cargo owner claims an insurance premium to an insurance company, the insurance company must pay the contracted insurance premium to the cargo owner unless the insurance company clearly illustrates that the fire started with the material loaded inside the container. Accordingly, since a right to indemnify a shipping company and a classification society according to the amount paid, the shipping company and the classification society are directly damaged. Moreover, for the shipping company, because maritime transportation insurance premiums are premium, price competitiveness decreases, potentially leading to a deterioration in a management of the company.

In conclusion, automatic fire extinguishing equipment having economic feasibility and reliability applicable in case of fire inside a ship transport container is equipment required by the shipping company, insurance company, classification society, and cargo consignment company in the times.

### SUMMARY

In order to effectively extinguish a fire inside a container of a container ship during maritime transportation, and to reduce a loss due to flame propagation to adjacent containers and a fire of a ship itself, a fire extinguishing facility should satisfy the following conditions.

1. Reduction of malfunction and failure factors due to simplification of equipment.

2. The fire extinguishing facility should be configured in consideration of the variable cargo loading capacity inside container.

3. The fire extinguishing facility should be applicable to types of cargo inside various containers.

4. Economical aspect of installation and maintenance costs.

5. When the fire extinguishing facility is installed inside an existing container, it should have a minimum install space.

6. Minimization of electrical equipment required for fire detection and suppression.

7. Prevents mutual damage and breakage generated by contact with equipment and cargo inside the container caused by vessel fluctuations due to sea climate.

8. Other related people should also describe and recognize after the fact whether an operation notification device of a fire extinguishing device is operated or a fire extinguishing agent gas is discharged in the event of a container fire occurring during maritime transportation.

9. After fire extinguishing, a fire extinguishing agent that can objectively preserve and discriminate a cause of fire inside the container should be used.

An object of the present disclosure provides a pipe-type fire extinguishing equipment for extinguishing a fire inside a ship transport container capable of exerting fire extinguishing performance in all materials except self-combustible materials (nitrocellulose, TNT, or the like) in which a chemical substance itself contains oxygen so as to satisfy the above conditions, and in terms of simplification of operation and configuration of the facility and installation cost, effectively extinguishing the fire inside the container during shipping using a clean fire extinguishing agent or a powder fire extinguishing agent in a low pressure or high pressure method as a mechanical starting method without using power.

According to an aspect of the present disclosure, there is provided a pipe-type fire extinguishing equipment for extinguishing a fire inside a ship transport container, the pipe-type first extinguishing equipment including: an agent storage part installed inside the container and configured to store a fire extinguishing agent for extinguishing a fire; a supply pipe connected to the agent storage part to receive and guide the fire extinguishing agent and installed in an upper portion inside the container; a spray hole communicating with the supply pipe to spray the fire extinguishing agent flowing through the supply pipe to an inside of the container; an opening/closing member installed inside the spray hole or the supply pipe and configured to open the spray hole or the supply pipe while being melted by heat when a fire occurs; and an alarm sound generation unit configured to be automatically opened to supply a compressed gas when a pressure of the fire extinguishing agent decreases to be equal to or less than a predetermined pressure as the fire extinguishing agent is sprayed through the supply pipe and spray hole when a fire occurs and generate a mechanical alarm sound.

According to the present disclosure, when a fire occurs inside the container, the opening/closing member that closes the spray hole of the pipe or is melted at a specific temperature by heat transferred through a spray hole of a steel pipe (supply pipe) surrounding a flexible plastic pipe is opened while being melted by heat, the fire extinguishing agent in the storage container can be automatically sprayed into the container through the spray hole in a powerless manner, and thus the fire inside the container can be extinguished quickly and effectively.

At this time, compressed gas exclusively for alarm sound generation is discharged to the alarm generation pipe due to a pressure drop of the agent storage part, and thus the fire can be effectively notified to external users.

In addition, leakage in a fire extinguishing facility can also be easily checked by means of a checking unit in a mechanical manner.

Therefore, simplicity and reliability in the operation and configuration of the fire extinguishing facility can be secured at the same time.

Since the fire extinguishing device of the present disclosure has compact configuration and size, the fire extinguishing device occupies a small installation space inside the container, and effectively releases the fire extinguishing agent into the container to extinguish the fire inside the container at an early stage. Accordingly, the fire extinguishing device has advantages of practicality and economy, and ability to preserve evidence when investigating the cause of fire.

### BRIEF DESCRIPTION OF THE DRAWINGS

FIG. 1 is a view illustrating a state in which a fire extinguishing facility according to one embodiment of the present disclosure is installed inside a container.

FIG. 2 is a perspective view illustrating an appearance of the fire extinguishing equipment according to one embodiment of the present disclosure.

FIG. 3 is a cross-sectional view illustrating a configuration of the fire extinguishing facility according to one embodiment of the present disclosure.

FIGS. 4A and 4B are cross-sectional views illustrating configuration and operation example for a fire extinguishing agent spray of the fire extinguishing facility according to one embodiment of the present disclosure.

FIG. 4C is a cross-sectional view illustrating various embodiments of an opening/closing member of the fire extinguishing facility according to one embodiment of the present disclosure.

FIGS. 5A and 5B are cross-sectional views of main portions illustrating various embodiments of a spray hole of the fire extinguishing facility according to the present disclosure.

FIG. 6 is a cross-sectional view of a main part illustrating an embodiment of an alarm sound generation unit of the fire extinguishing facility according to the present disclosure.

FIGS. 7A and 7B are views illustrating configuration and operation example of an embodiment of an alarm gas controller of the fire extinguishing facility according to one embodiment of the present disclosure.

FIGS. 8A and 8B are views illustrating configuration and operation example of another embodiment of the alarm gas controller of the fire extinguishing facility according to one embodiment of the present disclosure.

FIG. 9 is a block diagram schematically illustrating a more detailed configuration of the fire extinguishing facility of one embodiment of the present disclosure.

FIG. 10 is a cross-sectional view illustrating the configuration of a result display unit of a checking unit illustrated in FIG. 9.

FIGS. 11A and 11B is a flow chart illustrating an operation example of the fire extinguishing facility according to the present disclosure.

### DETAILED DESCRIPTION

Embodiments described in the present specification and configurations illustrated in the drawings are only preferred examples of the disclosed disclosure, and there may be various modification examples that may replace the embodiments and drawings of the present specification at the time of filing of the present application.

Hereinafter, pipe-type fire extinguishing equipment for extinguishing a fire inside a ship transport container will be described in detail according to embodiments described below with reference to the accompanying drawings. In the drawings, the same reference numerals denote the same components.

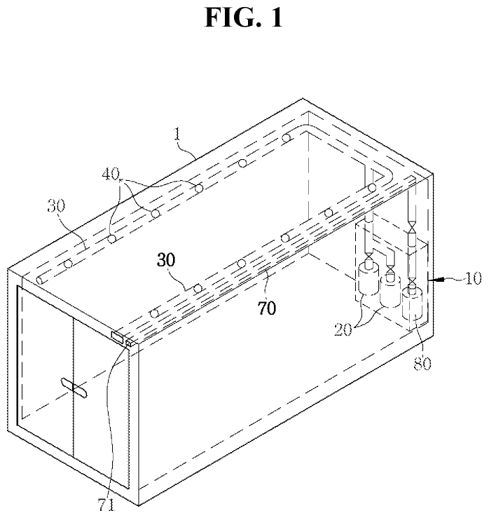

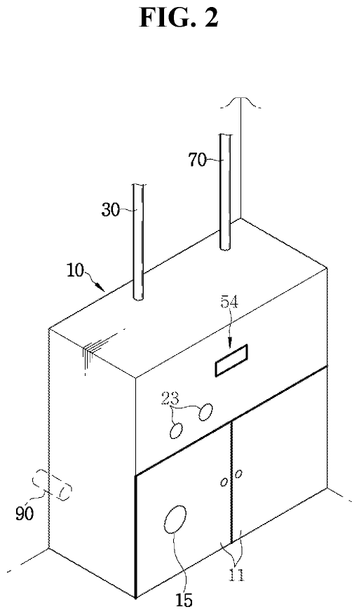

FIGS. 1 to 8B are views illustrating the pipe-type fire extinguishing equipment for extinguishing a fire inside a ship transport container according to one embodiment of the present disclosure.

First, referring to FIGS. 1 to 4C, the pipe-type fire extinguishing equipment for extinguishing a fire inside a ship transport container according to one embodiment of the present disclosure includes an agent storage part 20 that stores a fire extinguishing agent for extinguishing a fire, a supply pipe 30 that is connected to the agent storage part 20 to receive and guide the fire extinguishing agent and is installed in an upper portion inside the container, a plurality of spray holes 40 that communicates with the supply pipe 30 to spray the fire extinguishing agent flowing through the supply pipe 30 to an inside of the container 1, an opening/closing member 60 that is installed inside the spray hole 40 or the supply pipe 30 and opens the spray hole 40 or the supply pipe 30 while being melted by heat when a fire occurs to spray the fire extinguishing agent through the spray hole 40, an alarm sound generation unit that discharges a compressed gas such as a nitrogen gas (N2) when a pressure of the fire extinguishing agent applied to the inside decreases as the fire extinguishing agent is sprayed through the supply hole 40 when a fire occurs and generate a mechanical alarm sound, and a checking unit that checks whether the fire extinguishing agent leaks through the supply pipe 30a and the spray hole 40 in a state where a fire does not occur.

The agent storage part 20 is installed inside a casing 10 installed inside the container 1. The agent storage part 20 may be a storage container for a compressed fire extinguishing agent similar to a compressed powder fire extinguisher, or may be a storage container for a fire extinguishing agent that can store a clean fire extinguishing agent or a powder fire extinguishing agent that is not high pressure or high pressure and can supply and spray the fire extinguishing agent at a predetermined pressure.

In this embodiment, the agent storage part 20 is constituted by a plurality of fire extinguishing agent storage containers of high-pressure or low-pressure types and is installed inside the casing 10. A supply control valve 22 is installed between each agent storage part 20 and each supply pipe 30 to control the supply of fire extinguishing agent from the agent storage part 20 to the supply pipe 30. The supply control valve 22 is always open and temporarily closed by the operator when the agent storage part 20 is replaced. When the replacement is completed, the supply control valve 22 is opened again to supply the fire extinguishing agent from the agent storage part 20 to the supply pipe 30.

The casing 10 is installed to occupy a small install space inside the container 1. The casing 10 has a substantially rectangular housing shape and may be installed at a front or rear edge portion or one edge portion of the container 1.

A casing door 11 that opens and closes a space where the agent storage part 20 is installed, each agent storage part 20 accommodated in the casing 10, and two pressure gauges 23 indicating a pressure of a gas storage 80 of the alarm sound generation unit may be installed in a front surface of the casing 10. The casing door 11 may have various well-known door structures such as a double door type door or a slide type door. In this case, the pressure gauge 23 is installed in a concave shape inward to prevent damage due to a contact with a loaded cargo.

In addition, a leakage result display 54 constituting the checking unit is installed in the front surface of the casing 10 to be exposed to the outside. The leakage result display 54 may be protected by a transparent window. In this case as well, the leakage result display 54 is also installed in a concave shape to prevent damage due to the contact with the loaded cargo.

The supply pipe 30 is connected to an outlet of the agent storage part 20 to receive the fire extinguishing agent from the agent storage part 20 at all times. The supply pipe 30 extends upward from the agent storage part 20 and then is installed along an inner edge of the container 1, and thus, there is little interference between the supply pipe 30 and the cargo loaded inside the container 1. The supply pipe 30 may be installed singly, but as in this embodiment, a plurality of supply pipes 30 may be branched and installed on left and right sides of the upper edge.

The plurality of spray holes 40 are arranged in the supply pipe 30 at predetermined intervals. The spray hole 40 may be formed as a simple hole formed to penetrate the supply pipe 30, but may have a nozzle shape extending in one direction to the supply pipe 30 or a closed head shape of a sprinkler. Moreover, a flexible plastic pipe as the opening/closing member 60 that is melted at a specific temperature may be provided inside the spray hole 40. The spray holes 40 into which the opening/closing members 60 are installed are arranged in the supply pipe 30 at regular intervals.

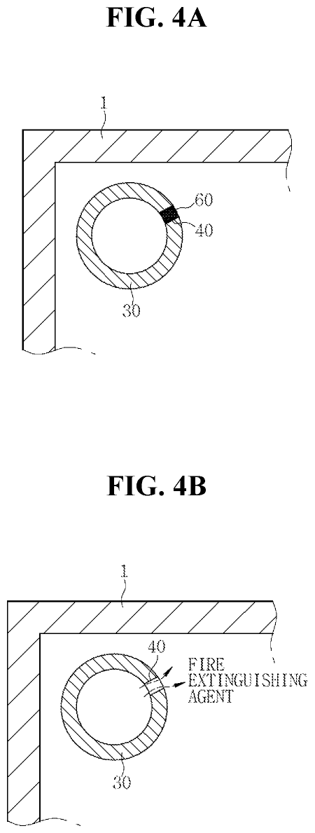

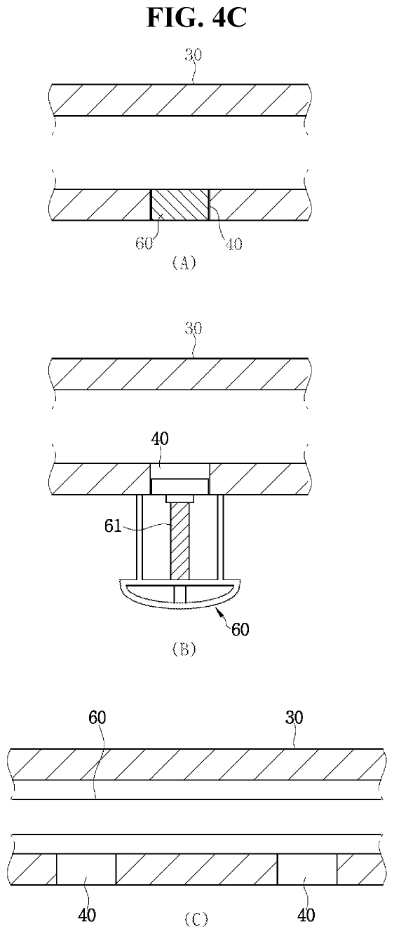

When the fire extinguishing agent is sprayed into the container 1 through the spray hole 40, preferably, as illustrated in FIG. 4B, the spray hole 40 is configured so that the fire extinguishing agent prevents deterioration of the extinguishing effect due to contact with the cargo loaded inside the container 1 and can spread uniformly throughout, and the fire extinguishing agent is sprayed toward a ceiling of the container 1.

The opening/closing member 60 is installed in the spray hole 40 or the supply pipe 30 and is melted by heat when a fire occurs. Accordingly, the spray hole 40 or the supply pipe 30 is opened so that the fire extinguishing agent can be sprayed through the spray hole 40. As illustrated in (A) of FIG. 4C, the opening/closing member 60 may be constituted by a hot melted material using lead (Pb) that closes the spray hole 40 inside the spray hole 40 and is melted at a temperature of about 80° C. when a fire occurs, or as illustrated in (B) of FIG. 4C, the opening/closing member 60 may be configured by applying a closed sprinkler head in which an opening/closing plate 62 opens the spray hole 40 when a molten metal material or glass bulb 61 melted at a specific temperature at the time of a fire is separated. In addition, differently, as illustrated in (C) of FIG. 4C, the opening/closing member 60 may be a flexible plastic pipe that is installed inside the supply pipe 30 made of steel, accommodates the fire extinguishing agent supplied from the agent storage part 20, and is melted at a specific temperature. Accordingly, when the opening/closing member 60 constituted by the flexible plastic pipe is melted by heat when a fire occurs, the fire extinguishing agent therein is sprayed to the outside through the plurality of spray holes 40 of the supply pipe 30 constituted by a steel pipe.

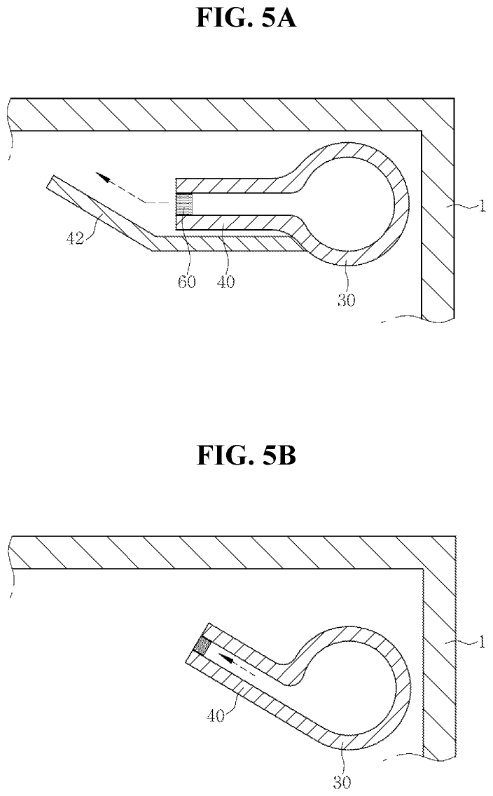

To this end, as illustrated in FIG. 5A, an agent reflection plate 42 that reflects the fire extinguishing agent toward the upper ceiling outside a front end portion of the spray hole 40 may be installed to be inclined upwardly toward the front, or as illustrated in FIG. 5B, the spray hole 40 may be formed to be inclined upward toward the front.

When the fire extinguishing agent is sprayed through the spray hole 40 when a fire occurs, the alarm sound generation unit supplies a compressed gas when the pressure of the fire extinguishing agent supplied to the supply pipe 30 decreases to be equal to or less than a predetermined pressure and mechanically generates an alarm sound, and thus, when a fire occurs, the alarm sound generation unit serves to inform external users that the fire has occurred.

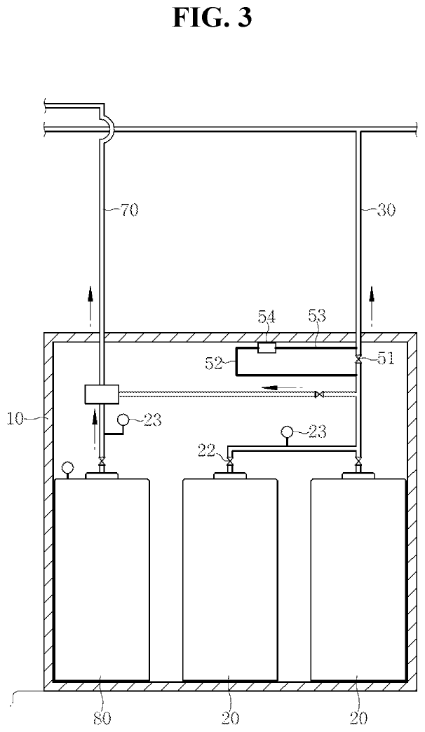

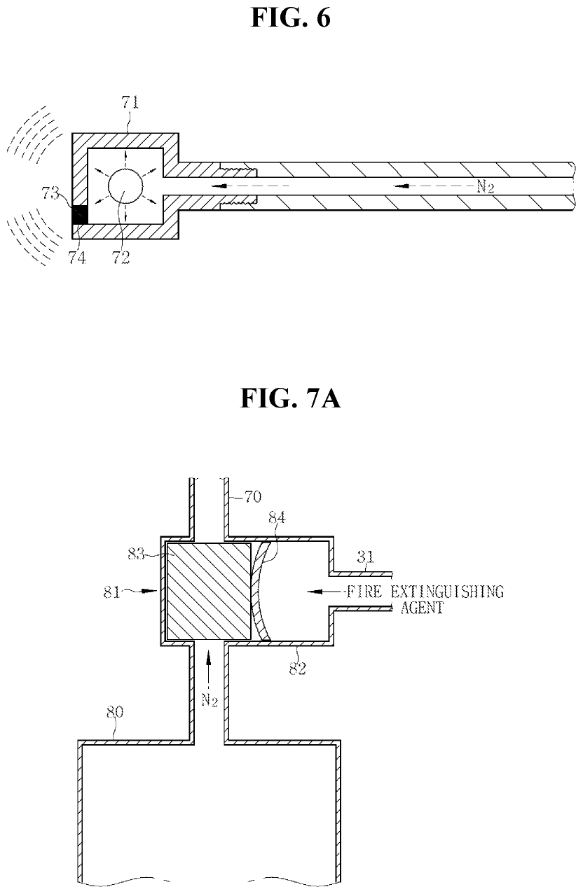

Referring FIGS. 3 and 6, the alarm sound generation unit includes a gas storage unit 80 that stores the compressed gas, an alarm gas controller 81 that is connected to an agent pressure transmission pipe 31 connected to the supply pipe 30 connected to the gas storage 80 and the agent storage part 20 and operated to be mechanically opened when the pressure of the fire extinguishing agent supplied from the agent pressure transmission pipe 31 decreases to be equal to or less than the predetermined pressure, an alarm gas transfer pipe 70 that is connected to the alarm gas controller 81 to transfer the compressed gas in the gas storage 80, a metal alarm generation pipe 71 that is coupled detachably to a front end portion of the alarm gas transfer pipe 70, installed to be exposed to an outside through one side surface of the container 1, and includes a through hole 73 formed to communicate with the outside of the container, a vibrator 72 that is installed inside the alarm generation pipe 71 and strikes the alarm generation pipe 71 to generate an alarm sound while being vibrated by the compressed gas flowing into the alarm generation pipe 71 through the alarm gas transfer pipe 70, and a rupture plate 74 that closes the through hole 73 and opens the through hole while being separated or removed from the through hole by the compressed gas when a fire occurs.

The rupture plate 74 closes the through hole 73 at in normal times when a fire does not occur, is separated or removed while being ruptured by the pressure of the compressed gas flowing into the alarm generation pipe 71 when a fire occurs, and opens the through hole 73. The rupture plate 74 is in contact with a contact surface of the alarm generation pipe 71 and is configured by joining a metal material or high-strength plastic with a rivet joint so that it is released by a predetermined pressure to a pressure of carbon dioxide when a fire occurs.

When the rupture plate 74 is ruptured and the through hole 73 is opened, preferably, the through hole 73 is formed to be inclined at a certain angle (for example, at an angle of approximately 45°) downward to prevent damage to the product due to rainwater entering through the through hole 73.

In order to allow an external third party to easily identify that the rupture plate 74 of the alarm generation pipe 71 has been removed, preferably, the alarm generation pipe 71 is installed at one corner of the upper end of a container door frame, for example, as illustrated in FIG. 1, near a right corner. It is preferable that the alarm generation pipe 71 enters the upper right frame of the door of the container 1 and is installed to be flat. That is, the alarm generation pipe 71 is installed on the upper right frame of the door of the container 1 so as to form the same plane as a surface of the frame when viewed from the outside.

When a fire occurs inside the container, the rupture plate 74 of the alarm generation pipe 71 is separated and cannot be reused. Therefore, preferably, a thread is formed in each of a rear end of the alarm generation pipe 71 and a front end portion of the alarm gas transfer pipe 70, and the alarm generation pipe 71 is separated from or recoupled to the front end portion of the alarm gas transfer pipe 70 in a screw coupling method so that the rupture plate 74 can be replaced. Of course, in addition to the screw coupling method, the alarm generation pipe 71 can be detachably coupled to the front end portion of the alarm gas transfer pipe 70 using a screw joint, a close joint, and a two-way union coupling joint.

The alarm gas controller 81 is configured to block or allow the supply of the compressed gas from the gas storage 80 to the alarm gas transfer pipe 70, according to the pressure of the fire extinguishing agent of the agent pressure transmission pipe 31 connected to the supply pipe 30 connected to the agent storage part 20. The agent pressure transmission pipe 31 includes a valve for controlling a flow of the fire extinguishing agent. There is no discharge of the fire extinguishing agent through the supply pipe 30 and spray hole 40 in normal times when a fire does not occur. Accordingly, the pressure of the fire extinguishing agent transferred to the alarm gas controller 81 through the agent pressure transmission pipe 31 is maintained high, the alarm gas controller 81 blocks a flow path connected from the gas storage 80 to the alarm gas transfer pipe 70. Moreover, when a fire occurs and the fire extinguishing agent is discharged through the supply pipe 30 and the spray hole 40, the pressure of the fire extinguishing agent transferred to the alarm gas controller 81 through the alarm pressure transmission pipe 31 decreases, the alarm gas controller 81 opens the flow path connected from the gas storage 80 to the alarm gas transfer pipe 70, the compressed gas is supplied from the gas storage 80 to the alarm gas transfer pipe 70, and thus the alarm sound generation unit generates an alarm sound.

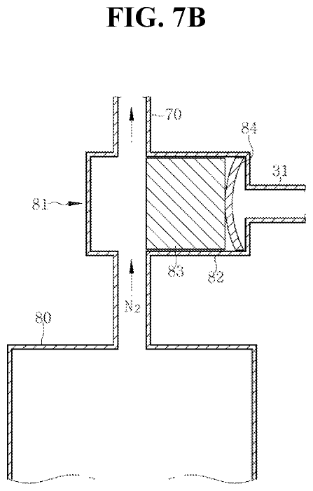

FIGS. 7A and 7B illustrate an embodiment of the alarm gas controller 81. The alarm gas controller 81 of this embodiment includes a control chamber 82 that is connected to the gas storage 80, the alarm gas transfer pipe 70, and the agent pressure transmission pipe 31, a diaphragm 84 that is installed inside the control chamber 82 and receives the pressure of the fire extinguishing agent supplied through the agent pressure transmission pipe 31, and an opening/closing block 83 that is installed to be adjacent to the diaphragm 84 inside the control chamber 82 and opens or close an inlet connected to the gas storage 80 and an outlet connected to the alarm gas transfer pipe 70 while horizontally sliding to a side by a pressure applied to the diaphragm 84.

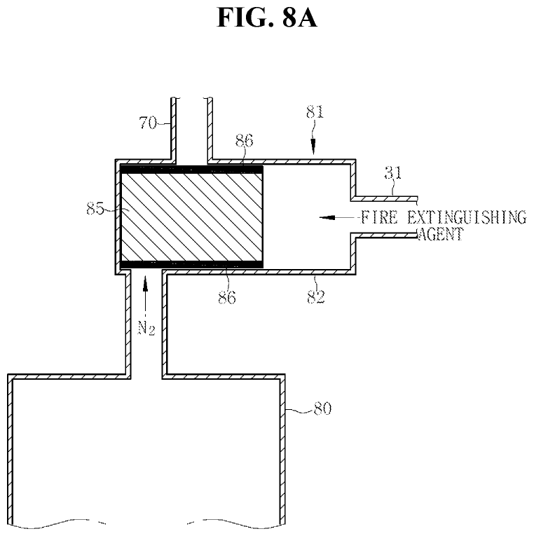

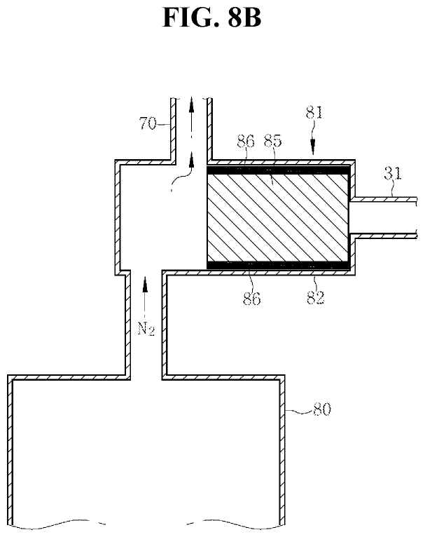

Moreover, FIGS. 8A and 8B illustrate another embodiment of the alarm gas controller 81. The alarm gas controller 81 of this embodiment includes the control chamber 82 that is connected to the gas storage 80, the alarm gas transfer pipe 70, and the agent pressure transmission pipe 31, a slide block 85 that is installed inside the control chamber 82 and receives the pressure of the fire extinguishing agent supplied through the agent pressure transmission pipe 81 to open or close the inlet connected to the gas storage 80 and the outlet connected to the alarm gas transfer pipe 70 while horizontally sliding to a side, and a slide sealing material 86 that is attached to each of an upper surface and a lower surface of the slide block 85 and slides along an upper surface and a lower surface of the control chamber 82.

Meanwhile, in normal times when a fire does not occur, when the opening/closing member 60 closing the spray hole 40 does not completely close the spray hole 40 or falls off, and the fire extinguishing agent leaks through the spray hole 40, in the event of an actual fire, the fire extinguishing equipment may not be operated properly. Therefore, it is necessary to periodically check whether the leakage of the fire extinguishing agent occurs in the agent storage part 20 side or the supply pipe 30 side in normal times and take appropriate measures in case of leakage.

For this, the checking unit is configured to detect the pressure of the fire extinguishing agent inside the supply pipe 30 to check whether the fire extinguishing agent leaks through the supply pipe 30 and spray hole 40 in a state where a fire does not occur.

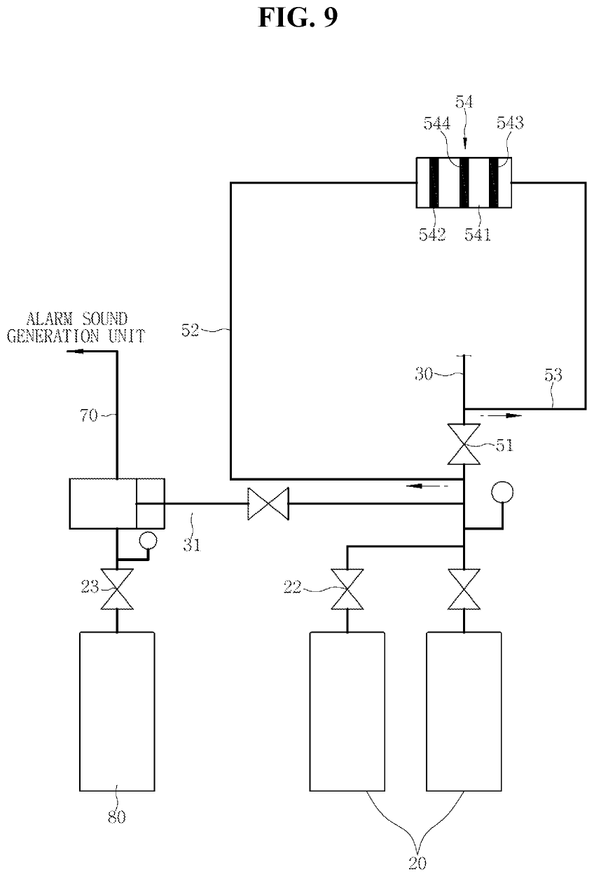

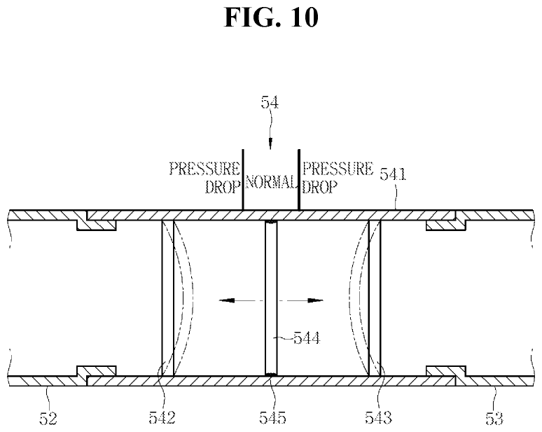

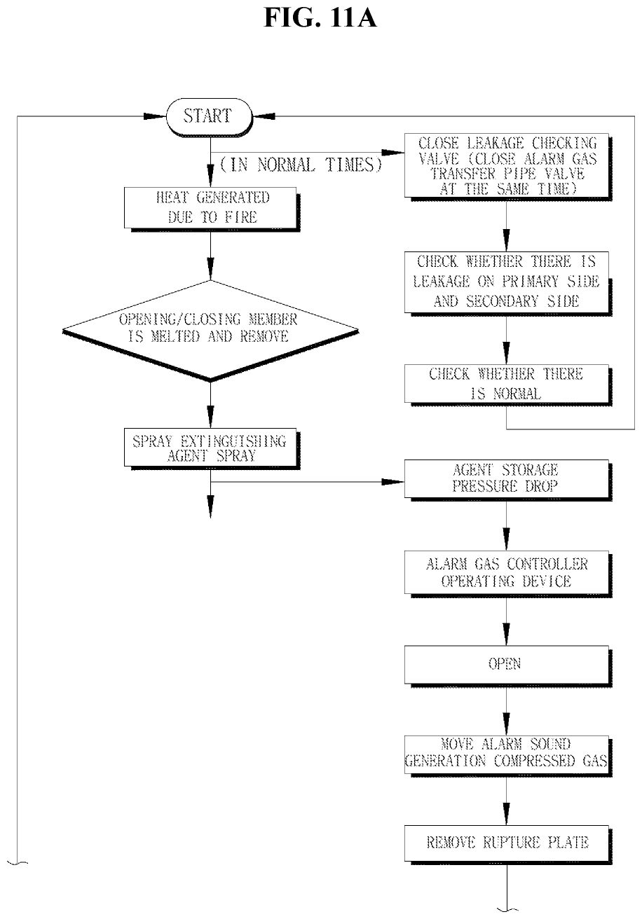

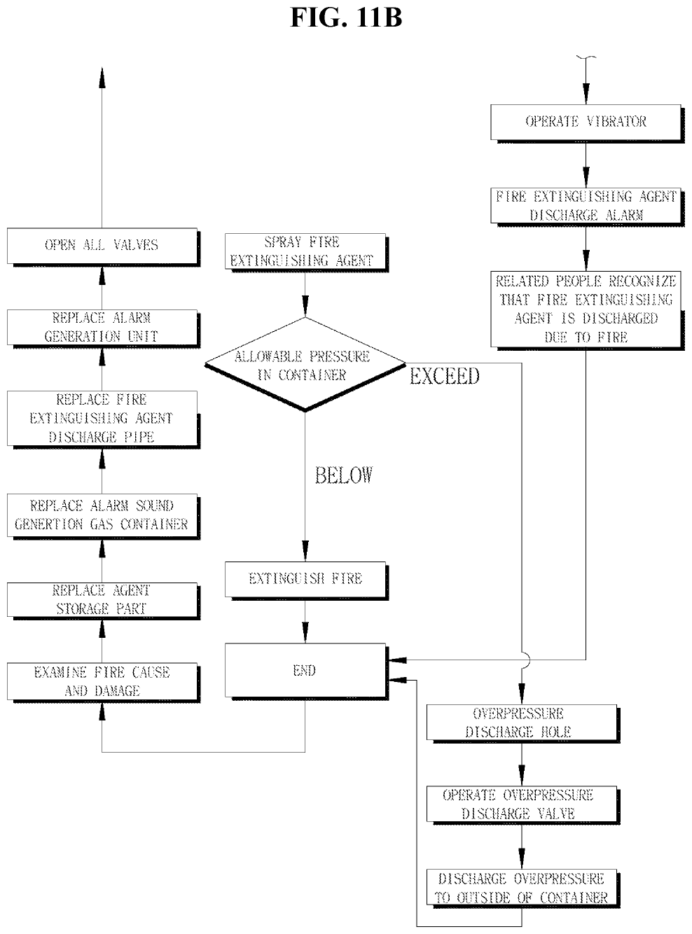

As illustrated in FIGS. 9 and 10, the checking unit includes a check valve 51 that is installed in the supply pipe 30, a primary-side pressure transmission pipe 52 of which one end is connected to a front side (upstream side) of the check valve 51 to receive the pressure of the fire extinguishing agent between the agent storage part 20 and the check valve 51 when the check valve 51 is closed, a secondary-side pressure transmission pipe 53 of which one end is connected to a rear side (downstream side) of the check valve 51 to receive the pressure of the fire extinguishing agent in a supply pipe on the rear side of the check valve, and a leakage result display 54 that is connected to the other end of the primary-side pressure transmission pipe 52 and the other end of the secondary-side pressure transmission pipe 53 and displays a difference between the pressure of the fire extinguishing agent transferred through the primary-side pressure transmission pipe 52 and the pressure of the fire extinguishing agent transferred through the secondary-side pressure transmission pipe 53 to the outside.

The leakage result display 54 includes a transparent check tube 541 of which both ends are respectively connected to the primary-side pressure transmission pipe 52 and the secondary-side pressure transmission pipe 53, a first diaphragm 542 and a second diaphragm 543 that are installed to seal both side portions of the check tube 541 and elastically deformed by receiving the pressure of the fire extinguishing agent transferred through the primary-side pressure transmission pipe 52 and the secondary-side pressure transmission pipe 53, and a movement diaphragm 544 that is disposed between the first diaphragm 542 and second diaphragm 543 and is moved by deformation of the first diaphragm 542 and second diaphragm 543. A slide bearing 545, which allows the movement diaphragm 544 to slide smoothly while rolling along the upper and lower surfaces inside the check tube 541, may be installed at an upper end and a lower end of the movement diaphragm 544.

A phrase or pattern indicating whether there is leakage may be displayed on the outer surface of the check tube 541. For example, “normal” may be display in a portion corresponding to a center between the first diaphragm 542 and the second diaphragm 543 and a “pressure drop” indicating that the leakage has occurred may be display on left and right sides of the portion marked as the “normal”. A “normal” pressure in an accumulator type fire extinguishing agent storage container is approximately 8 to 9 kg/cm2.

Meanwhile, when the fire extinguishing system is activated in the event of a fire, the fire extinguishing agent is sprayed to the inside of the container 1, and the inside of the container 1 is filled with the fire extinguishing agent. When the pressure inside the container 1 is excessively increased due to fire-generated smoke and the fire extinguishing agent sprayed thereto, strength of the container structure decreases, causing secondary damage due to collapse.

Accordingly, an overpressure discharge hole 15 is formed to penetrate front and rear portions of the casing 10, a through hole connected to the overpressure discharge hole 15 of a rear surface of the casing 10 on one surface of the container 1 is formed, and thereafter, an overpressure discharge valve 90 may be installed, which discharges a gas and the fire extinguishing agent to the outside of the container while being operated to be opened when a predetermined pressure or more is applied to the inside of the through hole.

The overpressure discharge valve 90 may be a safety valve in which a valve plate is supported by a spring with a constant force, and when a constant pressure is applied to the valve plate in a direction opposite to an elastic force of the spring, the valve plate overcomes the elastic force of the spring and moves to open a flow path, or may be various known pressure valves that is operated to be opened at a constant pressure or more.

Checking whether or not there is a leakage using the checking unit may be performed as follows.

When the check valve 51 is closed, the fire extinguishing agent is no longer supplied from the agent storage part 20 to the supply pipe 30.

If there is no leakage from the supply pipe 30 in this state, the pressure of the fire extinguishing agent transferred to the primary-side pressure transmission pipe 52 and the pressure of the fire extinguishing agent transferred to the secondary-side pressure transmission pipe 53 are almost the same. Accordingly, the pressures transferred to the first diaphragm 542 and the second diaphragm 543 in the check tube 541 are the same, and the movement diaphragm 544 is located at a center of the check tube 541.

However, when leakage occurs on the supply pipe 30 side or the agent storage part 20 side, the pressure of the fire extinguishing agent transferred to the primary-side pressure transmission pipe 52 and the pressure of the fire extinguishing agent transferred to the secondary-side pressure transmission pipe 53 are different from each other, a difference between the pressures transferred to the first diaphragm 542 and the second diaphragm 543 occurs. Accordingly, the first diaphragm 542 or the second diaphragm 543 is more deformed toward the movement diaphragm 544, the movement diaphragm (544) moves toward a side having a lower pressure, and thus, people can easily detect whether there is leakage from the outside. The pipe-type fire extinguishing equipment configured as described above is operated as follows.

In normal times, the supply control valve 22 and the check valve 51 are kept open, and the inside of the supply pipe 30 is filled with the fire extinguishing agent having a constant pressure.

When a fire occurs, the opening/closing member 60 is melted by heat of a flame and the spray hole 40 is opened. Accordingly, the fire extinguishing agent inside the supply pipe 30 is sprayed toward the ceiling of the container 1 through the spray hole 40 and diffuses to extinguish the fire inside the container 1.

At this time, as the fire extinguishing agent supplied from the agent storage part 20 to the inside of the supply pipe 30 is supplied, the pressure of the fire extinguishing agent applied to the alarm gas controller 81 decreases. Accordingly, as the alarm gas controller 81 is opened, the compressed gas (for example, nitrogen gas) in the gas storage 80 is supplied to the alarm generation pipe 71 through the alarm gas transfer pipe 70, and the rupture plate 74 in the alarm generation pipe 71 is separated by compressed gas and at the same time, the vibrator 72 is vibrated and an alarm sound is generated to notify the occurrence of fire.

As described above, the pipe-type fire extinguishing equipment of the present disclosure does not use any electrical devices and automatically releases the fire extinguishing agent into the container when a fire occurs. Accordingly, the fire can be extinguished quickly, and when a fire occurs, an alarm sound can be generated in a mechanical manner to notify the outside person, thus ensuring simplicity and reliability of operation and configuration.

In addition, the leakage in the fire extinguishing facility can also be easily checked by means of a checking unit in a mechanical manner.

Heretofore, the present disclosure is described in detail with reference to the embodiment. However, it is natural that a person of ordinary skill in the technical field to which the present disclosure belongs will be able to make various substitutions, additions, and modifications within a scope not departing from the technical idea described above, and it should be understood that the modified embodiments also belong to the scope of protection of the present disclosure, which is determined by the appended claims below.

The present disclosure is applied to a pipe-type fire extinguishing equipment for extinguishing a fire inside a ship transport container, wherein in the event of a fire in the container, the fire can be extinguished by automatically spraying a fire extinguishing agent into the closed container, and at the same time, a mechanical fire alarm can be operated to transmit a fire occurrence signal to the outside.

1. A pipe-type fire extinguishing equipment for extinguishing a fire inside a ship transport container, the pipe-type first extinguishing equipment comprising:
an agent storage part installed inside the container and configured to store a fire extinguishing agent for extinguishing a fire;
a supply pipe connected to the agent storage part to receive and guide the fire extinguishing agent and installed in an upper portion inside the container;
a spray hole communicating with the supply pipe to spray the fire extinguishing agent flowing through the supply pipe to an inside of the container;
an opening/closing member installed inside the spray hole or the supply pipe and configured to open the spray hole or the supply pipe while being melted by heat when a fire occurs; and
an alarm sound generation unit configured to be automatically opened to supply a compressed gas when a pressure of the fire extinguishing agent decreases to be equal to or less than a predetermined pressure as the fire extinguishing agent is sprayed through the supply pipe and spray hole when a fire occurs and generate a mechanical alarm sound.

2. The pipe-type first extinguishing equipment of claim 1, wherein the alarm sound generation unit includes a gas storage unit that stores the compressed gas, an alarm gas controller that is connected to an agent pressure transmission pipe connected to the supply pipe connected to the gas storage and the agent storage part and operated to be mechanically opened when the pressure of the fire extinguishing agent supplied from the agent pressure transmission pipe decreases to be equal to or less than the predetermined pressure, an alarm gas transfer pipe that is connected to the alarm gas controller to transfer the compressed gas in the gas storage, a metal alarm generation pipe that is coupled detachably to a front end portion of the alarm gas transfer pipe, installed to be exposed to an outside through one side surface of the container, and includes a through hole formed to communicate with the outside of the container, a vibrator that is installed inside the alarm generation pipe and strikes the alarm generation pipe to generate an alarm sound while being vibrated by the compressed gas flowing into the alarm generation pipe through the alarm gas transfer pipe, and a rupture plate that closes the through hole and opens the through hole while being separated or removed from the through hole by the compressed gas when a fire occurs.

3. The pipe-type first extinguishing equipment of claim 2, wherein the alarm gas controller includes a control chamber that is connected to the gas storage, the alarm gas transfer pipe, and the agent pressure transmission pipe, a diaphragm that is installed inside the control chamber and receives the pressure of the fire extinguishing agent supplied through the agent pressure transmission pipe, and an opening/closing block that is installed to be adjacent to the diaphragm inside the control chamber and opens or close an inlet connected to the gas storage and an outlet connected to the alarm gas transfer pipe while horizontally sliding to a side by a pressure applied to the diaphragm.

4. The pipe-type first extinguishing equipment of claim 2, wherein the alarm gas controller includes a control chamber that is connected to the gas storage, the alarm gas transfer pipe, and the agent pressure transmission pipe, a slide block that is installed inside the control chamber and receives the pressure of the fire extinguishing agent supplied through the agent pressure transmission pipe to open or close an inlet connected to the gas storage and an outlet connected to the alarm gas transfer pipe while horizontally sliding to a side, and a slide sealing material that is attached to each of an upper surface and a lower surface of the slide block and slides along an upper surface and a lower surface of the control chamber.

5. The pipe-type first extinguishing equipment of claim 1, further comprising:
a checking unit configured to detect the pressure of the fire extinguishing agent inside the supply pipe to check whether the fire extinguishing agent leaks through the supply pipe and spray hole in a state where a fire does not occur.

6. The pipe-type first extinguishing equipment of claim 5, wherein the checking unit includes a check valve that is installed in the supply pipe, a primary-side pressure transmission pipe of which one end is connected to a front side of the check valve to receive the pressure of the fire extinguishing agent between the agent storage part and the check valve when the check valve is closed, a secondary-side pressure transmission pipe of which one end is connected to a rear side of the check valve to receive the pressure of the fire extinguishing agent in a supply pipe on the rear side of the check valve, and a leakage result display that is connected to the other end of the primary-side pressure transmission pipe and the other end of the secondary-side pressure transmission pipe and displays a difference between the pressure of the fire extinguishing agent transmitted through the primary-side pressure transmission pipe and the pressure of the fire extinguishing agent transmitted through the secondary-side pressure transmission pipe to the outside.

7. The pipe-type first extinguishing equipment of claim 6, wherein the leakage result display includes a check tube of which both ends are respectively connected to the primary-side pressure transmission pipe and the secondary-side pressure transmission pipe, a first diaphragm and a second diaphragm that are installed to seal both side portions of the check tube and elastically deformed by receiving the pressure of the fire extinguishing agent transmitted through the primary-side pressure transmission pipe and the secondary-side pressure transmission pipe, a movement diaphragm that is disposed between the first diaphragm and second diaphragm and is moved by deformation of the first diaphragm and second diaphragm, and a slide bearing that is installed in each of an upper end and a lower end of the movement diaphragm and rolls along an upper surface and a lower surface of the check tube.

8. The pipe-type first extinguishing equipment of claim 1, wherein water is sprayed toward a ceiling of the container through the spray hole.

9. The pipe-type first extinguishing equipment of claim 1, wherein the agent storage part is formed in a housing shape to be received in a casing installed inside the container.

10. The pipe-type first extinguishing equipment of claim 9, further comprising:
an overpressure discharge hole configured to penetrate the casing; and
an overpressure discharge valve that is installed to be connected to the overpressure discharge hole on one surface of the container and discharges a gas inside the container while being operated to be opened when a predetermined pressure or more is applied through the overpressure discharge hole.

11. The pipe-type first extinguishing equipment of claim 1, wherein the opening/closing member is a hot melted material that closes the spray hole inside the spray hole and is melted at a specific temperature when a fire occurs.

12. The pipe-type first extinguishing equipment of claim 1, wherein the opening/closing member is a closed sprinkler head in which an opening/closing plate installed to close an inside of a spray hole opens the spray hole when a molten metal material or glass bulb melted at a specific temperature at the time of a fire is separated.

13. The pipe-type first extinguishing equipment of claim 1, wherein the opening/closing member is a flexible plastic pipe that is installed inside the supply pipe made of steel, melted at a specific temperature, and accommodates the fire extinguishing agent supplied from the agent storage part therein.
